(19) United States
(12) Patent Application Publication
(10) Pub. No.: US 2026/0309107 A1
(43) Pub. Date: Oct. 8, 2026

(54) Hydrogen Supply System for an Internal Combustion Engine

(71) Applicant: Robert Bosch GmbH, Stuttgart (DE)

(72) Inventors: Andreas Kremer, Waiblingen (DE); Tobias Wehling, Gerlingen (DE)

(21) Appl. No.: 19/484,863

(22) PCT Filed: Apr. 8, 2024
(86) PCT No.: PCT/EP2024/059448

§ 371 Date: Nov. 15, 2025

(30) Foreign Application Priority Data
May 16, 2023 (DE) 10 2023 204 553.2
May 26, 2023 (DE) 10 2023 204 922.8

(51) Int. Cl. F02M 21/02

(52) U.S. Cl. CPC F02M 21/0239; F02M 21/0206; F02M 21/0221; F02M 21/0242; F02M 21/0248

(57) ABSTRACT

A hydrogen supply system for an internal combustion engine includes an inlet-side high-pressure region, an outlet-side low-pressure region and a medium-pressure region which is arranged fluidically between the high-pressure region and the low-pressure region. A mechanical pressure-reducing device is provided to lower a high pressure in the high-pressure region to a medium pressure in the medium-pressure region. An electrically actuable pressure-reducing device is provided to lower the medium pressure in the medium-pressure region to a low pressure in the low-pressure region. A pressure-limiting valve and, downstream of the latter, a shut-off valve are arranged in the middle-pressure region and/or in the low-pressure region. The hydrogen supply system can include, in particular, a single hydrogen supply unit (“one-box solution”).

### PRIOR ART

From DE 10 2016 205 713 A1 of the Applicant, a pressure control system for gas-powered engines is already known, with a gas line for supplying gaseous fuel to a gas valve, wherein a pressure regulator for adjusting a constant gas pressure is arranged in the gas line, and with a shut-off valve located between the pressure regulator and a tank container in which gas is at high pressure.

### DISCLOSURE OF THE INVENTION

The invention proceeds from the inventors' request to provide as simple a hydrogen supply system as possible for an internal combustion engine.

According to the present invention it is provided that the hydrogen supply system is provided with an inlet-side high-pressure region, with an outlet side low-pressure region and with a medium-pressure region which is arranged fluidically between the high-pressure region and the low-pressure region, wherein a mechanical pressure-reducing device is provided to lower a high pressure in the high-pressure region to a medium pressure in the medium-pressure region, and wherein an electrically actuable pressure-reducing device is provided to lower the medium pressure in the medium-pressure region to a low pressure in the low-pressure region.

The high pressure may be, for example, a pressure in the range of 200 to 700 bar corresponding to a pressure in a hydrogen tank of the hydrogen supply system or a hydrogen tank to which the hydrogen supply system is connected on the high pressure side. For example, the medium pressure may be a pressure ranging from 35 bar to 200 bar, for example a pressure of 40 bar. For example, the low pressure may be a pressure that can dynamically vary between 15 bar and 35 bar, depending on the operating state of the internal combustion engine, and that is provided for blowing the hydrogen into a combustion chamber of the internal combustion engine.

For safety reasons, the provision of at least one shut-off valve in such a hydrogen supply system is mandatory in order to be able to fluidically completely shut off at least the portion of the low-pressure region located in the flow direction from the high-pressure region.

In this case, the shut-off valve can in particular be configured as an electrically actuable, closed switching valve. This is thus a valve that has only two switching states, open and closed, but cannot remain in intermediate states due to design. In this respect, it is different from proportional valves, which can remain in intermediate states when they are electrically controlled accordingly. Proportional valves are therefore in particular not shut off valves in the sense of the invention.

The shut-off valve of the hydrogen supply system or the hydrogen supply unit (see below) may differ from a proportional valve also comprised by the hydrogen supply system or the hydrogen supply unit in that the shut-off valve has a greater fluid cross-section than the proportional valve.

In order to be able to provide as simple a hydrogen supply system as possible for an internal combustion engine under this boundary condition, it is further provided according to the invention that a shut-off valve is arranged in the medium-pressure region or in the low-pressure region.

The arrangement of the shut-off valve in the medium-pressure region or low-pressure region makes it possible to significantly simplify the shut-off valve from a technical standpoint, as it only needs to be capable of shutting off the medium pressure or low pressure, but not the high pressure. It can therefore be used as a medium-pressure shut-off valve or low-pressure shut-off valve, and a high-pressure shut-off valve in the hydrogen supply system could be omitted.

However, it was subsequently recognized that mechanical pressure-reducing devices are prone to leakage, which cannot be ruled out. This means that if the shut-off valve closes in the medium-pressure region or low-pressure region, this leakage could gradually build up pressure in the medium-pressure region or low-pressure region that corresponds to the high pressure and for which the medium-pressure shut-off valve or low-pressure shut-off valve is not designed.

Since the invention also provides for a pressure-limiting valve in the medium pressure range or low-pressure region, the pressure in the medium-pressure region or low-pressure region can be limited to the medium pressure or low pressure by this valve, even if the pressure in low-pressure region, the pressure in the medium-pressure region or low-pressure region can be limited to the medium pressure or low pressure by this, even if the shut-off valve in the medium-pressure region or low-pressure region is closed and at the same time the mechanical pressure-reducing device has a non-negligible leakage.

For example, the pressure-limiting valve may be configured as a drain valve through which hydrogen can be discharged into the environment of the hydrogen supply system when a pressure in the medium-pressure region or low-pressure region exceeds the medium pressure or low pressure. For example, it may be a spring-loaded check valve.

In a further development of the invention, the possibility for simplification of the hydrogen supply system can be realized by designing it with a hydrogen tank and fluidically extending the high-pressure region from the hydrogen tank to the mechanical pressure-reducing device without interposing a shut-off valve, and, if necessary, also fluidically extending the medium-pressure region from the mechanical pressure-reducing device to the electrically actuable pressure-reducing device interposing a shut-off valve. Thus, in other words, the hydrogen supply system is realized without a high-pressure shut-off valve and even without a medium-pressure shut-off valve, if necessary. This represents a significant technical simplification because the technical complexity of shut-off valves decreases from high-pressure shut-off valves to medium-pressure shut-off valves to low-pressure shut-off valves.

In a further development of the invention, a fuel distributor and a plurality of injectors fluidically connected to it may also be provided in the low-pressure region, through which hydrogen can be injected into the combustion chambers of the internal combustion engine.

On the other hand, the hydrogen supply system may also be a hydrogen supply unit comprising a housing, inside of which a fluid channel is arranged, in which the mechanical pressure-reducing device, the electrically actuable pressure-reducing device, the pressure-limiting valve and the shut-off valve are arranged.

The housing can in particular be an integral housing, which is produced as a cast body, for example, or by machining, for example from aluminum or steel.

Alternatively, the housing can also consist of two or more partial housings, which are connected to each other, in particular in a non-detachable manner. The partial housings may in turn be made as a casting or by machining, for example, from aluminum or steel.

A high-pressure connection piece communicating with the fluid channel may be provided on the high-pressure side of such a hydrogen supply unit for connection to a high-pressure line. It may be a connection piece for detachable connection, e.g. screwing on, of a high-pressure line.

A low-pressure connection piece communicating with the fluid channel may be provided on the low-pressure side of such a hydrogen supply unit for connection to a low-pressure line. It may be a connection piece for detachable connection, e.g. screwing on, of a low-pressure line.

The hydrogen supply unit can in particular be a compact component that extends in length, width and height to a maximum of 40 cm, in particular to a maximum of 30 cm, or even to a maximum of 25 cm.

The hydrogen supply unit may in particular be part of a comprehensive hydrogen supply system further comprising the tank, high pressure line, low pressure line, fuel routers and/or injectors components already described above.

The hydrogen supply unit or the hydrogen supply system or the comprehensive hydrogen supply system may comprise a pressure sensor and/or a filter device in the high-pressure region, the mid-pressure region and/or the low-pressure region.

Embodiments of the invention are explained in greater detail below with reference to the accompanying drawing. The drawings show:

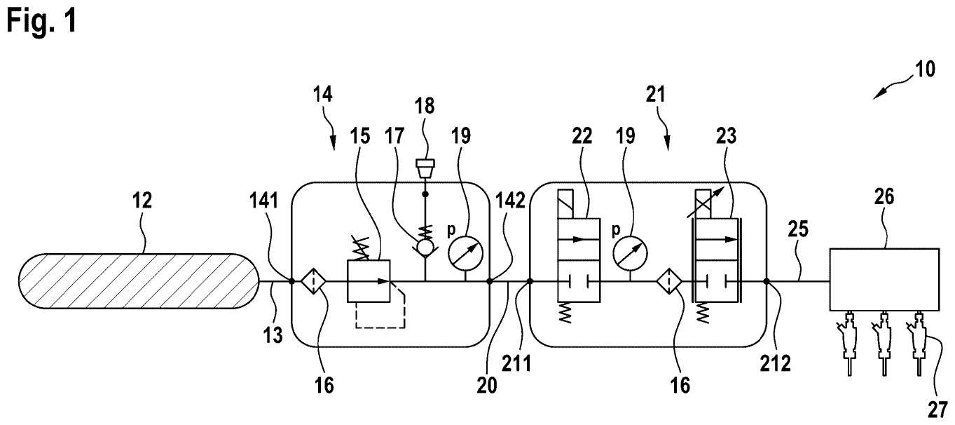

FIG. 1 a first exemplary embodiment of the invention.

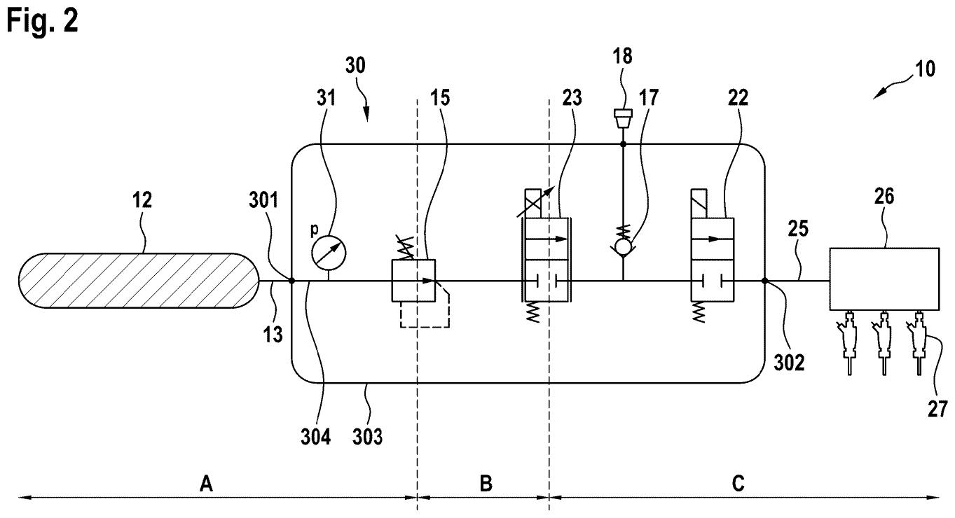

FIG. 2 a second embodiment example of the invention.

FIG. 1 shows a further exemplary embodiment of the invention. A hydrogen supply system 10 for an internal combustion engine comprises a hydrogen tank 12 in which hydrogen is stored at high pressure (e.g., 700 bar) and releasably connected via a high-pressure line 13 to a first pressure-reducing unit 14 via a high-pressure connection piece 141.

The first pressure-reducing unit 14 is realized as an integral unit and further comprises a mechanical pressure-reducing device 15 for lowering the high pressure to a medium pressure, for example to 40 bar. The first pressure reducing unit 14 also comprises a particle filter 16 on the inlet side and, downstream of the mechanical pressure-reducing device 15, a pressure-limiting valve 17 designed as a check valve, which opens as soon as it is subjected to a pressure on the inlet side that is greater than the medium pressure, and then discharges hydrogen from the hydrogen supply system 10 through a discharge opening 18. The pressure-limiting valve 17 may also be referred to as a discharge valve in this respect. Downstream of the mechanical pressure-reducing device 15, a medium pressure sensor 19 is further provided in the first pressure-reducing unit 14.

The first pressure-reducing unit 14 is releasably connected downstream via its medium-pressure connection piece 142 to a medium-pressure line 20, which in turn is releasably connected downstream to the input connection piece 211 of a second pressure-reducing unit 21.

The second pressure-reducing unit 21 is realized as an integral unit. In the direction of flow, the second pressure-reducing unit 21 also has a shut-off valve 22, another medium-pressure sensor 19, a particle filter 16, and an electrically actuable pressure-reducing device 23, which in the example is designed as a proportional valve, connected in series. It is used to lower the medium-pressure to a low pressure.

Via its low-pressure connection piece 212, the second pressure-reducing unit 21 is releasably connected to a low-pressure line 25, which is further connected to a fuel distributor 26 that supplies hydrogen to several injectors 27 connected to it in a fluidic manner.

The shut-off valve 22 in the example is a medium-pressure check valve, that is to say, it is designed to shut off hydrogen having a medium pressure, for example 40 bar, due to design. However, it is not a high-pressure shut-off valve and therefore not designed to shut off hydrogen at a high pressure, for example 250 bar or 700 bar, due to design. The shut off valve 22 may thus be a comparatively simple component.

Since the pressure-limiting valve 17 is connected upstream of the shut-off valve 22 in the example, the occurrence of a pressure greater than the medium pressure at the shut-off valve 22 is always reliably prevented, even in the event of shut-off and if a certain amount of leakage occurs at the mechanical pressure-reducing device 15.

According to the first exemplary embodiment (FIG. 1), the first pressure-reducing unit 14 and the second pressure-reducing unit 21 are realized as two separate units each having their own housing (“two-box solution”).

FIG. 2 shows a second exemplary embodiment of the invention. A hydrogen supply system 10 for an internal combustion engine comprises a hydrogen tank 12 in which hydrogen is stored at high pressure (e.g., 700 bar) and releasably connected via a high-pressure line 13 to a hydrogen supply unit 30 via a high-pressure connection piece 301. On the opposite side, the hydrogen supply unit 30 is releasably connected via its low pressure connection piece 302 to a low-pressure line 25, which is further connected to a fuel distributor 26, which supplies hydrogen to a plurality of injectors 27 fluidically connected thereto.

The hydrogen supply unit 30 comprises an integral housing 303 in the example, which is made of aluminum or steel, for example by casting or machining. Inside the housing 303 of the hydrogen supply unit 30, a fluid channel 304 extends from the high-pressure region A via the medium-pressure region B to the low-pressure region C, i.e. from connection piece 301 to connection piece 302.

In the fluid channel 304, in the order of the direction of flow, there is a high-pressure sensor 31, a mechanical pressure-reducing device 15 for reducing the high pressure to a medium pressure, for example to 40 bar, an electrically actuable pressure-reducing device 23 for dynamically variably reducing the medium pressure to a low pressure, for example 15 bar to 35 bar, a pressure-limiting valve 17, and a shut-off valve 22 are provided.

In the example, the electrically actuable pressure-reducing device 23 is configured as a proportional valve. The pressure-limiting valve 17 is configured as a check valve that opens once it is exposed to a pressure greater than the highest expected low pressure and then discharges hydrogen from the hydrogen system 10 through a discharge opening 18. The pressure-limiting valve 17 may also be referred to as a discharge valve in this respect.

The shut-off valve 22 in the example is a low-pressure shut-off valve, which means that it is designed to shut off hydrogen at the highest expected low pressure, for example 35 bar, or the medium pressure, for example 40 bar. However, it is not a high-pressure shut-off valve and therefore not designed to shut off hydrogen at a high pressure, for example 250 bar or 700 bar, due to design. The shut off valve 22 may thus be a comparatively simple component.

Since the pressure-limiting valve 17 is connected upstream of the shut-off valve 22 in the example, the occurrence of a pressure greater than the medium pressure at the shut-off valve 22 is always reliably prevented, even in the event of shut-off and if a certain amount of leakage occurs at the mechanical pressure-reducing device 15 and at the electrically actuable pressure-reducing device 23.

According to the second design example (FIG. 2), a hydrogen supply unit 30 is realized as a single unit that reduces a pressure of the hydrogen in two stages from high pressure to a low pressure via the medium pressure and has a single housing (“one-box solution”).

1. A hydrogen supply system for an internal combustion engine with (i) an inlet-side high-pressure region, (ii) an outlet-side low-pressure region, and (iii) a medium-pressure region which is arranged fluidically between the high-pressure region and the low-pressure region, comprising:
a mechanical pressure-reducing device configured to lower a high pressure in the high-pressure region to a medium pressure in the medium-pressure region,
an electrically actuable pressure-reducing device configured to lower the medium pressure in the medium-pressure region to a low pressure in the low-pressure region, and
a pressure-limiting valve and, downstream thereof, a shut-off valve arranged in the middle-pressure region and/or in the low-pressure region.

2. The hydrogen supply system according to claim 1, further including a hydrogen tank, wherein the high-pressure region extends fluidically from the hydrogen tank to the mechanical pressure-reducing device without interposing a shut-off valve.

3. The hydrogen supply system according to claim 1, wherein the medium-pressure region extends fluidically from the mechanical pressure-reducing device to the electrically actuatable pressure-reducing device without interposing a shut-off valve.

4. The hydrogen supply system according to claim 1, further comprising a fuel distributor and at least one injector fluidically connected thereto in the low-pressure region.

5. The hydrogen supply system according to claim 1, further comprising a housing, inside of which a fluid channel is arranged,
wherein the mechanical pressure-reducing device, the electrically actuable pressure-reducing device, the pressure-limiting valve and the shut-off valve are also arranged in the housing.

6. The hydrogen supply system according to claim 5, further comprising:
a high-pressure connection piece communicating with the fluid channel on the high-pressure side of the housing for connection to a high-pressure line, and
a low-pressure connection piece communicating with the fluid channel for connection to a low-pressure line on the low-pressure side of the housing.

7. The hydrogen supply system according to claim 1, wherein the pressure-limiting valve is configured as a discharge valve through which hydrogen is discharged into the environment of the hydrogen supply system when a pressure in the medium-pressure region or the low-pressure region exceeds the medium pressure.

8. The hydrogen supply system according to claim 1, further comprising a pressure sensor and/or a filter device arranged in the high-pressure region, the medium-pressure region and/or the low-pressure region.
